(19) United States
(12) Patent Application Publication
(10) Pub. No.: US 2012/0249985 A1
(43) Pub. Date: Oct. 4, 2012

(54) MEASUREMENT OF AN IMAGING OPTICAL SYSTEM BY SUPERPOSITION OF PATTERNS

(75) Inventors: Lars WISCHMEIER, Aalen (DE); Rolf FREIMANN, Aalen (DE)

(73) Assignee: CARL ZEISS SMT GMBH, Oberkochen (DE)

(21) Appl. No.: 13/436,804

(22) Filed: Mar. 30, 2012

Related U.S. Application Data
(60) Provisional application No. 61/470,108, filed on Mar. 31, 2011.

(30) Foreign Application Priority Data
Mar. 31, 2011 (DE) 10 2011 006 468.0

(51) Int. Cl. G03B 27/42; G01B 9/08

(52) U.S. Cl. 355/53; 356/124

(57) ABSTRACT

A device for measuring an imaging optical system, including: a first grating pattern (6), which is positionable in a beam path upstream of the imaging optical system, having a first grating structure (16), a second grating pattern (8), which is positionable in the beam path (4) downstream of the imaging optical system, having a second grating structure (18), and a sensor unit for the spatially resolving measurement of a superposition fringe pattern produced during the imaging of the first grating structure (16) of the first grating pattern (6) onto the second grating structure (18) of the second grating pattern (8). The first grating structure (16) differs in its correction structures (17) from the second grating structure (18).

This application claims priority from German Patent Application No. 10 2011 006 468.0, filed on Mar. 31, 2011, and U.S. Provisional Application No. 61/470,108, filed on Mar. 31, 2011, the entire disclosures of which are incorporated herein by reference.

### BACKGROUND OF THE INVENTION

The invention relates to a device and to a method for measuring an imaging optical system by superposition of patterns, to a projection exposure apparatus having a device of this type, and to a sensor unit for use in a measurement of this type.

U.S. Pat. No. 5,973,773 and U.S. Pat. No. 5,767,959 disclose a device for distortion measurement, in which a first grating having a first pitch is arranged on a transparent substrate between a light source and an optical system, the distortion of which is intended to be measured. A second grating having a second (different) pitch is arranged on a further transparent substrate between the optical system and a sensor for recording an image. During illumination of the two gratings, a Moiré fringe pattern having a pitch which exceeds the pitch of the first and second gratings by a plurality of orders of magnitude is produced on the sensor. The distortion of the optical system is measured by comparing the illumination intensity on the sensor with the expected intensity for the case in which no distortion is present in the optical system. In one exemplary embodiment, the transparent substrate with the second grating is arranged directly on the sensor in order to save installation space.

DE 10 2008 042 463 B3 describes an optical measurement device for a projection exposure apparatus for microlithography, which has an optical sensor for measuring a property of the exposure radiation and also a data interface which is configured for transferring the measured property in the form of measurement data to a data receiver arranged outside the measurement device. The measurement device can be configured as a plate so as to arrange the measurement device in a wafer plane of the projection exposure apparatus.

DE 102 53 874 A1 discloses a method for producing an optical function component and an associated function component. The function component has a frequency conversion layer for converting electromagnetic radiation of a first wavelength range into electromagnetic radiation in a second wavelength range. The frequency conversion layer can produce a force-fitting connection between two optical components of the function component and be configured for example in the form of a fluorescent kit. The function component can serve for example for producing grating substrates for the Moiré measurement technique.

WO 2009/033709 A1 discloses a measurement apparatus in the form of an imaging microoptical unit for measuring the position of an aerial image. The microoptical unit which has a magnifying optical unit (microscope objective, for example for magnification by a factor of 200 or 400) and deflecting mirrors can be arranged in the region of a wafer stage and be motion-coupled with it or integrated in it. Using such a microoptical unit, it is possible to carry out an incoherent comparison between the aerial images of different lithography apparatuses.

US 2009/0257049 A1 describes a device for measuring a lithography apparatus using a Moiré measurement technique. Here, a Moiré grating is provided on a window which is attached at the bottom of a container which is fillable with an immersion liquid. The window can be composed of a fluorescent material in order to convert non-visible radiation, for example UV radiation, into visible radiation.

It is also known of projection exposure apparatuses for microlithography to use what is referred to as “Optical Proximity Correction” (OPC) correction structures in order to image structures on a mask, the distances between which are near the resolution limit of an imaging optical system used in this case. These OPC correction structures make it possible to produce—in conjunction with an illumination distribution which is matched to the correction structures or to the structure to be imaged in each case (what is referred to as “Source-Mask Optimization”)—an image of the structure to be imaged in the object plane of the imaging optical system, which image corresponds to the structures of the mask to be imaged (without correction structures).

### OBJECT OF THE INVENTION

It is the object of the invention to provide a device, a projection exposure apparatus having a device of this type, a method and a sensor unit, which permit precise measurement of imaging optical systems at the limit of their resolution capabilities to be carried out, in particular if this limit depends on the position and orientation of the imaged structures, for example in obscurated optical systems.

### SUBJECT MATTER OF THE INVENTION

This object is achieved by way of a device for measuring an imaging optical system by superposition of patterns, comprising: a first grating pattern, which is positionable in a beam path upstream of the imaging optical system, having a first grating structure, a second grating pattern, which is positionable in the beam path downstream of the imaging optical system, having a second grating structure, and a sensor unit for the spatially resolving measurement of a superposition fringe pattern produced during the imaging of the first grating structure of the first grating pattern onto the second grating structure of the second grating pattern. In the device for measuring by superposing patterns, the first grating structure deviates in a predetermined manner from the second grating structure such that the first grating structure cannot be converted by a scale transformation into the second grating structure or the first grating structure and the second grating structure differ (even when scaled to the same size) by way of correction structures.

In conventional measurement methods for measuring by superposition of patterns, which are also referred to as Moiré methods, the first grating pattern is arranged in the object plane and the second grating pattern is arranged in the image plane of the optical system to be measured and the two superposing grating structures are selected such that they can be converted into each other by a scale transformation, i.e. changing the scale (magnification or demagnification with the imaging scale of the optical system). For example, with an imaging scale of 0.25, as is often used in lithography apparatuses, the grating structures of the first grating pattern can be converted into the grating structures of the second grating pattern by way of demagnification by a factor of 4.

The inventors have recognized that for precise characterization of the optical properties of an optical system, in particular the distortion or “Critical Dimension” (CD), not only the properties of the imaging optical system itself are important but rather also the structures to be imaged and the illumination settings. For the comparison of two or more optical systems, in particular in terms of their suitability for multiple exposure, it is not necessary to determine separately from one another the influence of the illumination system, of the structures to be imaged and of the imaging optical system on the result of the measurement. Rather it suffices if in the optical systems to be compared identical conditions are produced, i.e. the same structure to be imaged and the same illumination settings are selected and the results of the measurement of both optical systems are compared to each other. Such a comparison can be carried out “in situ” for two or more optical systems which are in operation, for example for two projection exposure apparatuses which are located at different sites.

In order to precisely measure by way of the superposition of patterns it is necessary for the pitches of the grating lines of a respective grating structure to be very small and thus the spatial frequency of the grating lines to be selected to be so large that the structure size of the grating structures or of the grating lines approaches the resolution limit of the imaging optical system. In order to ensure that even in the case of such small pitches the image of the first grating structures matches in terms of its form and geometry as precisely as possible the second grating structures, it is proposed to change the grating structures so that they deviate from one another and cannot be converted into each other by way of scale transformation, i.e. magnification or demagnification (with the imaging scale of the optical system to be measured).

For this purpose, the grating structures of the first grating pattern and/or the grating structures of the second grating pattern can have correction structures. The correction structures are chosen here such that during the imaging using the correction structures the image of the first grating structure approaches the second grating structure more strongly than would be the case without the use of the correction structures.

In particular, the grating structures of the first grating pattern at selected locations can be changed locally such that during the imaging in the image plane an optimum image, i.e. scaled by the imaging scale and matching as closely as possible the grating structures of the second grating pattern, of the grating structures of the first grating pattern is produced. The use of correction structures in the superposition of the patterns is possible because—as explained above—it is not necessary to characterize the properties of the imaging optical system alone, i.e. without the influence of the structure to be imaged. It should be appreciated that the evaluation of the superposition fringe pattern of the two grating structures in the measurement method proposed here can be carried out analogous to conventional Moiré measurement methods.

In one embodiment, the first grating structure has OPC correction structures. These are intended to serve for generating an image of the first grating structure, which—as accurately as possible—matches the second grating structures of the second grating pattern. In order to image grating structures near the resolution limit of the imaging system it is proposed to use what are referred to as “Optical Proximity Correction” (OPC) correction structures which—if necessary in conjunction with an illumination distribution matched to the correction structures or to the grating structure to be imaged—produce the desired image in the object plane of the imaging optical system, which in the ideal case corresponds to the second grating structure of the second, image-side grating pattern. Such OPC correction structures are for example described in US 2006/0248497 A1, which is incorporated in this application by reference.

In one development, the device has an illumination system for illuminating the first grating structure of the first grating pattern, wherein at least one illumination parameter of the illumination system is matched to the correction structures. In order to obtain, during the imaging of the first grating structure, an image which matches the second grating structure as precisely as possible, the illumination parameters of the illumination system can be matched to the correction structures used or to the first grating structures used. To this end, manipulators for providing different illumination settings such as dipole or quadrupole illumination or also for setting flexible illumination pupils can be used in the illumination system. In particular, exchangeable illumination filters, for example plate-type illumination filters, can be provided as manipulators in the illumination system, which allow different illumination settings, which can in particular also be matched to the respectively used grating pattern or to the grating structure used in each case. The combination of illumination settings and correction structures for producing a desired image is also referred to as “Source-Mask Optimization” and is typically based on computer models of the imaging properties of the imaging optical system to be measured.

In one embodiment, the first and the second grating pattern have a plurality of grating structures, wherein the pitches of the grating lines of different grating structures differ from one another. In this embodiment, a plurality of grating structures are provided at different locations of a common grating pattern in order to be able to assess the transfer function of the imaging optical system at different pitches. Grating structure is here understood to mean a finite surface area with periodic structure. The grating structure can be configured for example as a line grating, dot grating, as a structure with angled grating lines, etc.

In one further embodiment, the first and the second grating pattern have a plurality of grating structures with different spatial orientation. Alternatively or in addition to the selection of different pitches, it is also possible for different orientations of the grating lines of the grating structures to be selected in order to allow the zeroth, first and if appropriate higher orders of diffraction required for the optical transfer or imaging to run in different azimuthal directions through the imaging optical system and to be able to measure these. The grating lines of the differently orientated grating structures can here in particular together enclose an angle other than 90° and for example be arranged at an angle of 45°, 30° etc. with respect to one another.

In one development, the pitches and/or the spatial orientation of the grating structures are selected such that a zeroth or higher order of diffraction produced by the first grating structures of the first grating pattern are obscurated (shaded) or absorbed at least partially by the imaging optical system. The pitches of these grating structures are also referred to as “forbidden pitches.” The grating structures of the first grating pattern are preferably chosen on the basis of a mathematical model in a targeted manner such that it must be assumed that the imaging of the grating structures by the optical system inside the aperture used, which is determined by the external aperture stop, is limited. This is the case for example if the pitches and/or the orientation of the grating structures is selected such that the zeroth or higher orders of diffraction is/are not completely transferred so that the image contrast in the superposition of the grating structures of the two grating patterns to form the superposition fringe pattern decreases. A similar contrast-reducing effect can also be caused by stray light with limited range (“flare”) or by aberrations. In all imaging systems, shadings of orders of diffraction of the structures to be imaged occur either by the aperture stop at the edge or by obscuration stops (in the center). The last case is referred to as central obscuration, i.e. part of the pupil plane inside the aperture used is obscurated, for example because a through-opening is provided on a mirror arranged in the region of the pupil. Such systems are described for example in DE 10 2008 046 699 A1, DE 10 2008 041 910 A1, US6,750,948 B2 or WO 2006/069725 A1. In so-called obscurated optical systems of this type, the limit of the resolution capability and thus the contrast of the superposition fringe pattern depend on the position and orientation of the grating structures. In addition to obscurations, gaps between segments of segmented mirrors can also have a corresponding effect.

In one further embodiment, the device additionally comprises at least one movement apparatus for displacing the grating patterns relative to one another. Since in the case of the superposition measurement technique used here the grating patterns are moved relative to one another, in particular displaced, it is possible to distinguish between the changes in contrast of the superposition fringe pattern caused by stray light, obscurations and aberrations. Stray light, for example, with limited range thus results in reduced contrast in the superposition of grating structures, the half-pitches of which correspond to the stray-light range. Anisotropic stray light formation also reduces the contrast in dependence on the orientation of the grating structures differently and can therefore be recognized.

In one further embodiment, the sensor unit comprises a spatially resolving detector, in particular a CCD detector, and also the second grating pattern in a common structural unit. The common structural unit preferably has a structural height of less than 1.2 mm. Owing to the integration of the second grating pattern and of the detector in a common structural unit, it is possible to produce a portable sensor unit. This sensor unit can, in particular with a structural height of 1.2 mm or less, be arranged as a plate-type structural unit in the image plane of a projection objective of a projection exposure apparatus in place of a wafer.

Such a low structural height of the sensor unit can be achieved by using a conventional CCD camera chip, which is optimized if appropriate additionally with respect to its structural height, as a detector. A protective glass attached to the light-sensitive layer or the light-sensitive detector surface of the CCD camera chip can be removed to decrease the structural height. It should be appreciated that the other dimensions of the sensor unit (in particular its diameter) are also selected such that they do not exceed the dimensions of a wafer.

A sensor unit of this type can be introduced in different projection exposure apparatuses in order to carry out a measurement, for example a distortion measurement. An associated object-side grating pattern can here be introduced in place of a mask (“reticle”) in an object plane of a projection objective or of a projection system. In this manner it is possible for a plurality of projection exposure apparatuses to be measured in situ in order to examine their suitability with respect to multiple exposure or in order to be able to match the optical properties of the projection exposure apparatuses with respect to multiple exposure.

In one development a frequency conversion element (quantum converter layer) for wavelength conversion is arranged between the second grating pattern and the detector, which frequency conversion element preferably has a thickness of between 1 μm and 100 μm, in particular between 10 μm and 50 μm. The wavelength conversion also enables detection of radiation incident in the image plane at large aperture angles, which, in particular in immersion systems, owing to the critical angle of the total internal reflection being exceeded cannot be coupled out of the protective glass without a wavelength conversion and then coupled into the detector. Owing to the wavelength conversion it is also possible for the transfer of the grating lines onto the detector to be suppressed without using a (relay) optical unit for this purpose which is connected between grating pattern and detector surface and acts as a low-pass filter. To this end, the frequency conversion element is arranged directly, i.e. at a distance of typically at most circa 20 μm, from the grating pattern or from the grating structure and has a sufficient thickness to prevent non-frequency-converted radiation from impinging on the detector surface.

In one advantageous development, the frequency conversion element is configured as a protective glass for the spatially resolving detector. In particular, the protective glass can be configured as a fluorescent glass or as a scintillation glass. In the former case, the protective glass serves for wavelength conversion between the UV wavelength range (e.g. between approximately 120 nm and approximately 400 nm) and the visible wavelength range (e.g. between approximately 500 nm and approximately 700 nm). A commercially available fluorescent glass with the desired properties is for example the so-called Lumilass glass from Sumita. In particular suitable for use of the sensor unit for measuring projection systems of EUV lithography apparatuses by superposition of patterns are scintillation glasses, which allow conversion of radiation in the EUV range (approximately 10 nm to 50 nm) to the visible wavelength range. For example P43 phosphor layers, as are offered for example by Proxitronic, have proven suitable for the present applications.

A further aspect of the invention relates to a projection exposure apparatus for microlithography, comprising: an in particular obscurated projection objective as an imaging optical system, and a device for measuring the projection objective which is configured as described above. The projection exposure apparatus or the projection objective can be adapted for radiation in the UV wavelength range, for example at 193 nm, or for radiation in the EUV wavelength range (at 13.5 nm). In particular, the projection objective can have a (central) obscuration.

A further aspect of the invention relates to a sensor unit for measurement by superposition of patterns, in particular for a device as described above, comprising: a spatially resolving detector, in particular a CCD detector, a grating pattern having at least one grating structure, and a frequency conversion element, arranged between the grating pattern and a radiation-sensitive detector surface of the spatially resolving detector, in the form of a protective glass, mounted onto the detector surface, for wavelength conversion for radiation that is incident on the sensor unit. As illustrated above, owing to the frequency conversion element, a relay optical unit need not be provided.

In one embodiment, the sensor unit has a structural height of less than 1.2 mm. Such a low structural height can be achieved by way of a flat design of the spatially resolving (CCD) detector combined with the omission of a relay optical unit, because the height of the grating structures or of the frequency conversion element is negligibly low. As described above, such a flat sensor unit can be arranged in place of a wafer on a wafer stage.

In a further embodiment, the protective glass is a fluorescent glass or a scintillation glass, depending on whether the imaging optical system to be measured is operated with VUV radiation or with EUV radiation.

In a further embodiment, the spatially resolving detector has laterally arranged electric contacts for transmitting measurement signals. The electrical contacts—for example in the form of connecting pins of the CCD camera chip—are guided out laterally from the detector so as not to increase the structural height of the sensor unit and to transfer measurement data or measurement signals out of the region in which the structural space is limited. It should be appreciated that electrical contacts can be dispensed with if sufficient storage space is available in the detector or if an interface for wireless transmission of measurement data is present.

In a further embodiment, between 5 and 50 grating lines or more than 1000 grating lines are situated on a respective pixel of the light-sensitive detector surface or layer of the spatially resolving detector. Typically an individual pixel (i.e. a region of the sensor with a measurement signal which is integrated or averaged over the area of the pixel) has a size in the range of for example approximately 10 μm×10 μm. Since typical line densities of grating lines in superposition measurement technology using VUV radiation are in the region of approximately 1000 to 2000 lines (line pairs) per mm (in the image plane), a number of approximately 10 to 20 grating lines is obtained, which contribute to the irradiation intensity per pixel. It is possible, owing to the frequency conversion layer, to prevent these grating lines from being transferred onto the CCD detector.

If the sensor unit is used for measuring imaging optical systems, which are operated with EUV radiation, smaller structural widths of the latent image in the photoresist are striven for so that the demands on the accuracy of a comparison of different lithography apparatuses with respect to the distortion increase. These increased demands can be accommodated by an increased line density of the grating lines, for example by using 2000 to 10 000 line pairs per mm. Since the wavelength of the EUV radiation (typically 13.5 nm) even with the use of 10 000 line pairs per mm is smaller even than the pitch of approximately 100 nm, such a grating operates advantageously in shade casting mode. It should be appreciated that such high line densities can also be used to measure optical systems which operate in the VUV range, wherein such high line densities are within the resolution limit range of these systems such that correction structures should be provided if appropriate on the object-side grating pattern.

A further aspect of the invention relates to a method for measuring an imaging optical system, in particular a projection objective for microlithography, by superposition of patterns, comprising: measuring a superposition fringe pattern, which is produced by imaging a first grating structure of a first grating pattern, which is arranged upstream of the imaging optical system, onto a second grating structure of a second grating pattern, which is arranged downstream of the imaging optical system, displacing the two grating patterns relative to one another while at the same time determining the contrast of the superposition fringe pattern, and determining obscurations, aberrations, a stray-light range and/or distortion of the imaging optical system by evaluating the contrast of the Moiré fringe pattern during the relative movement of the grating patterns.

As was already described further above in connection with the device for measuring by superposition of patterns, obscurations of the imaging optical system, aberrations or the stray-light range can be determined on the basis of the contrast of the measured superposition fringe pattern. It should be appreciated that in the above-described method it is likewise possible in the case of the first grating pattern to use grating structures which have correction structures so that the grating structures of the first grating pattern cannot be converted into the grating structures of the second grating pattern by way of scaling using the imaging scale of the imaging optical system.

In one variant, in a preceding method step, the first grating structures on the first grating pattern are formed with pitches and/or orientations which are selected such that the zeroth or higher order of diffraction produced by the first grating pattern is obscurated or absorbed at least partially by the imaging optical system. It should be appreciated that a corresponding second, image-side grating pattern with the same pitches and orientations is also produced, wherein the imaging scale of the imaging optical system is taken into consideration. Additionally or alternatively, the pitches and/or orientations can be selected such that they are in the region of an expected (if appropriate anisotropic) stray-light range of the imaging optical system such that the stray-light range can also be detected by way of a reduced contrast of the superposition fringe pattern. Owing to an appropriate selection of the pitches or orientations of the grating structures, it is also possible to better detect aberrations of the imaging optical system.

In a development of the method, the pitches and/or the orientations of the grating lines are determined on the basis of a mathematical model of the beam path through the imaging optical system. A mathematical-optical model of the imaging optical system, which can be established for example with the aid of conventional optics programs, makes it possible to determine at which pitches or orientations of the grating lines the zeroth and/or first order of diffraction produced by the grating structures of the first grating pattern is at least partially obscurated such that a reduction of the image contrast of the superposition fringe patterns occurs during the measurement.

In a further variant, the method comprises the performing of a correction on the imaging optical system by changing at least one illumination parameter of an illumination system, which is connected upstream of the imaging optical system, in dependence on the obscurations determined during the measurement, absorbing regions, the determined stray-light range and/or distortion. On the basis of the measurement data determined during the measurement relating to the imaging optical system, it is possible for a correction of the imaging to be carried out by appropriately adjusting illumination parameters of an illumination system which is connected upstream of the imaging optical system.

A further aspect of the invention relates to a device for measuring an imaging optical system by superposition of patterns, comprising: a first pattern, which is positionable in a beam path upstream of the imaging optical system, having a first structure, a second pattern, which is positionable in the beam path downstream of the imaging optical system, having a second structure, and a sensor unit for the spatially resolving measurement of a superposition pattern produced during the imaging of the first structure of the first pattern onto the second structure of the second pattern, wherein the first structure deviates in a predetermined manner from the second structure such that the first structure cannot be converted by a scale transformation into the second structure.

This aspect of the invention represents an extension of the aspect described further above, in which periodic patterns (grating patterns) are imaged on top of one another, to any desired (not necessarily periodic) patterns or structures. In this case, too, the first structure can have correction structures, in particular OPC correction structures, in order to produce during the imaging an image of the first structure which corresponds as accurately as possible to the second structure of the second pattern. It should be appreciated that alternatively or additionally the second structure can also have correction structures in order to approximate the image of the first structure to the second structure.

The first pattern can in particular be an exposure mask for lithography optics which has a structure to be imaged which is used for patterning a substrate (wafer).

Since the second structure of the second pattern is reduced in size with respect to the first structure of the first pattern by the imaging scale of the imaging optical system, it has proven expedient for the second structure of the second pattern to be produced by way of electron beam writing or using another suitable method for micropatterning.

Further features and advantages of the invention result from the following description of exemplary embodiments of the invention with respect to the figures of the drawing, which illustrate details which are essential to the invention, and from the claims. The individual features can be realized in each case individually by themselves or in groups in any desired combination in a variant of the invention.

### DRAWING

Exemplary embodiments are illustrated in the schematic drawing and will be explained below in the following description.

FIG. 1 shows a schematic illustration of a device for measuring an imaging optical system by superposition of patterns,

FIG. 2 shows a schematic illustration of a first grating structure with OPC correction structures and a second grating structure, which is reduced in size by the imaging scale, without OPC correction structures,

FIG. 3 shows a schematic illustration of a plurality of grating structures with different orientation and different spacings between the grating lines,

FIG. 4 shows a flow diagram of a method for measuring an imaging optical system by superposition of patterns,

FIG. 5 shows a schematic illustration of a sensor unit in flat construction for the device of FIG. 1,

FIG. 6 shows a schematic illustration of a plurality of pixels, which are arranged next to one another, of a spatially resolving detector of the sensor unit of FIG. 5,

FIGS. 7a,b show schematic illustrations of a measurement arrangement for the coherent comparison of aerial images of two lithography exposure apparatuses for multiple exposures, and

FIG. 8 shows an obscurated EUV projection objective with a device for measuring by superposition of patterns.

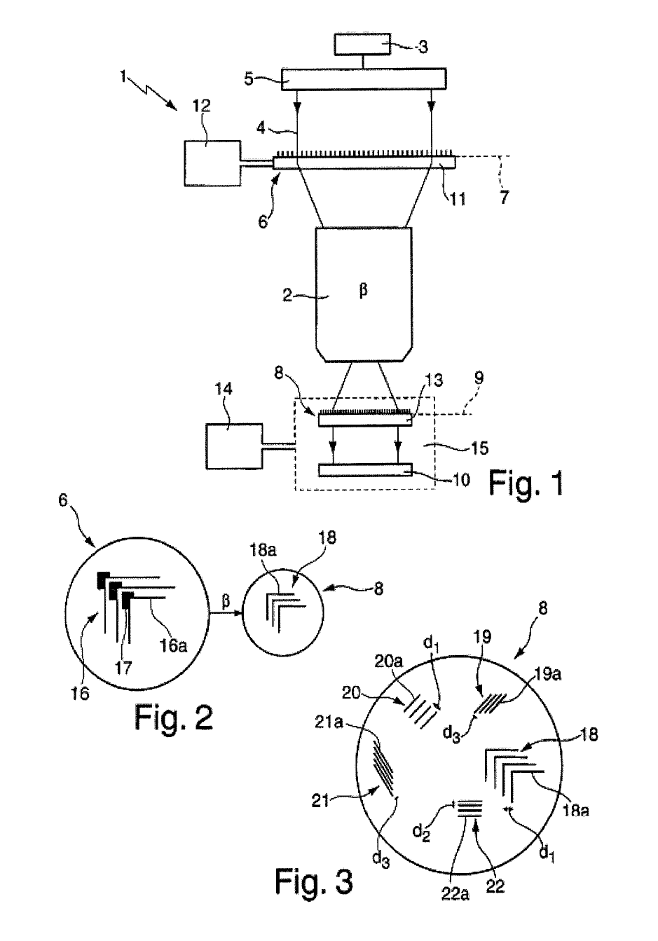

FIG. 1 schematically shows a device 1 for measuring an imaging optical system 2 in the form of a projection objective for microlithography by superposition of patterns. The projection objective 2 in the present example is adapted for operating with a radiation of a wavelength of 193 nm, which is generated by a laser 3 as the light source. The laser light is supplied to an illumination system 5 which produces a beam path 4 with a homogenous, sharply delimited image field for illuminating a first grating pattern 6, which is arranged in an object plane 7 of the projection objective 2.

The first, object-side grating pattern 6 comprises a grating structure (not shown in more detail in FIG. 1) which is imaged using the projection objective 2 onto a grating structure (likewise not illustrated in more detail in FIG. 1) of a second, object-side grating pattern 8, which is arranged in an image plane 9 of the projection objective 2.

During the imaging of the object-side grating pattern 6 onto the image-side grating pattern 8 with an imaging scale β of the projection objective 2, which can be for example 0.25, a superposition fringe pattern is produced which has a pitch which is larger than the pitch of the grating structures of the first and second grating patterns 6, 8 by a plurality of orders of magnitude. A spatially resolving detector 10, which is arranged under the second grating pattern 8, serves for capturing the superposition fringe pattern, which can be evaluated using an evaluation apparatus (not shown).

The object-side grating pattern 6 has a transparent substrate 11, which can be displaced using a movement apparatus 12 in the form of a linear displacement apparatus which is known per se in the object plane 7. Accordingly, the image-side grating pattern 8 also has a transparent substrate 11 and can be displaced together with the detector 10 using a further movement apparatus 14 in the image plane 8. In order to permit a common displacement of detector 10 and second grating pattern 8, they are accommodated in a common structural unit 15.

As is shown in FIG. 2, the first grating pattern 6 has an angled grating structure 16 having a plurality of grating lines 16a which are arranged with a constant distance between them. Furthermore, each grating line 16a of the first grating pattern 6 has a correction structure 17 at a corner of the angled grating structure 16. This correction structure will also be referred to below as “Optical Proximity Correction” (OPC) correction structure, since this term is used for correction structures of conventional exposure masks. As can likewise be seen in FIG. 2, the second grating pattern 8 has an angled grating structure 18, which is reduced in size by the imaging scale β of the projection objective 2, with grating lines 18a but without correction structures, i.e. the first grating structure 16 cannot, as is usually the case in Moiré gratings, be converted into the second grating structure 18 by a scale transformation with the imaging scale β of the projection objective 2.

The OPC correction structures 17, illustrated by way of example at the corners of the grating lines 16a, are intended to be used for, when imaging the grating structure 16 into the image plane 9, the forming of an image which corresponds as precisely as possible to that of the second grating structure 18 of the second grating pattern 8, as is indicated in FIG. 2 by way of an arrow with the imaging scale β. The geometry and the location at which the OPC correction structures are arranged on the first grating pattern 6 are typically determined on the basis of a mathematical model of the beam path through the projection objective 2. In particular, it is possible here to take into account the influence of the illumination system 5 on the imaging or for the selection of a suitable illumination setting of the illumination system 5 to take place in correspondence with the determination of a suitable correction structure 17. The measurement thus takes place with an illumination setting or with illumination parameters which are determined in dependence on the selected grating pattern 6 or the selected correction structures 17 in order to be able to reproduce as precisely as possible the second grating structure 18 when imaging the first grating structure 16.

The characteristic parameters to be determined in the measurement using the device 1 such as distortion etc. are measured on a fringe pattern which is produced by superposition of the image of the first grating structure 16 with the second grating structure 18 in the image plane 9. Here the first grating pattern 6 and the second grating pattern 8 are displaced relative to each other in order to enable a phase-shifting evaluation of the superposition fringe pattern, as is described for example in U.S. Pat. No. 6,816,247 by the applicant for a conventional Moiré measurement technology.

The first and second grating patterns 6, 8 typically have not only a single grating structure 16, 18 but a plurality of grating structures, as is illustrated in FIG. 3 by way of example for the second grating pattern 8 with five grating structures 18 to 22. The grating lines 18a to 22a of the grating structures 18 to 22 have in the present example three different pitches d1 to d3 and different orientations. In this case, for example, the grating lines 19a of the first grating structure 19 and the grating lines 22a of the fifth grating structure 22 extend at an angle of 45°, wherein the grating lines of different grating structures can in principle enclose any desired angles with respect to one another. It should be appreciated that grating structures, which correspond to the grating structures 18 to 22 of the second grating pattern (taking into consideration the imaging scale β), are formed at the first grating pattern 6, wherein these can be supplemented in addition as shown in FIG. 2 by correction structures 17.

Matching of the pitches and the orientation of the grating structures 18 to 22 to the optical system to be measured, in the present case to the projection objective 2, typically takes place with respect to the measurement parameters to be determined in the measurement. For example the pitches d1 to d3, as well as the spatial orientation of the grating structures 18 to 22, can thus be chosen such that a first order of diffraction, which is produced by the first grating structure 16 of the first grating pattern 6, is at least partially obscurated by the imaging optical system 2, which results in a reduction of the contrast of the superposition fringe pattern which can be measured in the evaluation.

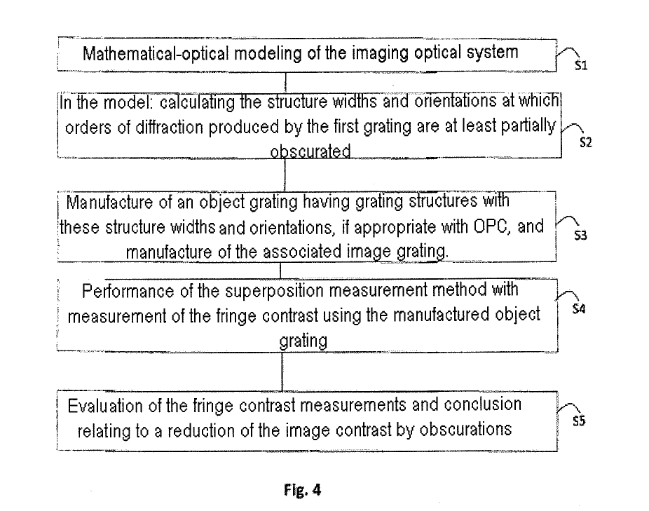

FIG. 4 illustrates a flow diagram of a method process for detecting such obscuration-based image contrast reductions. Here, in a first step S1, mathematical-optical modeling of the imaging system to be measured, in the present example of the projection objective 2, is carried out. On the basis of the mathematical model, in a second step S2, structure widths or pitches and orientations for the grating structures are determined, in which orders of diffraction (or at least the zeroth and/or first order of diffraction), produced by the first grating pattern 6, are at least partially obscurated.

In a third step S3, a first, object-side grating pattern 6 and an associated second, image-side grating pattern 8 in each case with grating structures is produced, which have the desired pitches or orientations, wherein if appropriate—but not necessarily—correction structures, for example in the form of OPC correction structures, can be arranged on the grating structures of the first grating pattern.

In a further, fourth step S4, the measurement is then carried out in the manner described in connection with FIG. 1 (i.e. the two grating patterns 6, 8 are displaced relative to each other) and the contrast of the superposition fringe pattern produced is determined. In a fifth and last method step S5, the fringe contrast measurements are evaluated and conclusions relating to the reduction of the contrast owing to obscurations which are caused by the imaging optical system are drawn.

Additionally or alternatively to the measurement of the projection objective 2 with respect to obscurations using the method shown in FIG. 4, it is possible on the basis of the change, in particular of the reduction of the contrast of the superposition fringe patterns, for the stray-light range of in particular short range stray light (“flare”) of the projection objective 2 to also be determined. By way of example, stray light with limited range results in reduced contrast in pitches in grating structures, the half-pitches of which correspond to the stray-light range. Anisotropic stray-light formation also differently reduces the contrast in dependence on the orientation of the grating structures and can therefore be detected. In addition, the measurement of the superposition fringe contrast or the reduction of the contrast of the superposition fringe pattern can also lead to aberrations of the projection objective being detected.

On the basis of the change of the contrast of the superposition fringe patterns, it is thus possible for obscurations, absorbing regions, the stray-light range and aberrations of the projection objective 2 to be determined and for conclusions relating to the uniformity which is dependent on these measurement variables of the “Critical Dimension” (“CD Uniformity”) of the projection objective 2 to be drawn. The “CDU” is an important parameter in particular for multiple exposures because multiple exposures in lithography apparatuses with comparable CDU values works better than in lithography apparatuses in which the CDU values differ more greatly from one another.

The above-described procedure for measuring the projection objective 2 is not limited to imaging periodic structures (grating structures). Rather it is also possible for any desired (aperiodic) structures to be imaged onto one another. In particular the first pattern in this case can be an exposure mask for lithography optics, i.e. the first structures are provided for exposure of a wafer. The second structures of the second mask can in this case be produced by direct writing, for example using an electron beam.

In the case of the device 1 for measuring in FIG. 1, it was assumed that the structural unit 15 with the detector 10 and the second grating pattern 8 is a fixed component of the device 1, which represents a measurement location for characterizing different optical systems. However, it should be appreciated that for characterizing a plurality of optical systems, in particular a plurality of lithography apparatuses, it may be more expedient to provide, in place of a positionally fixed measurement device, a sensor unit in the form of a mobile structural unit which is configured such that it can be introduced into the wafer stages of different lithography apparatuses in order to be able to carry out a measurement by superposition of patterns. In particular, the sensor unit should be configured in this case such that it can be positioned in place of a wafer on a wafer stage, i.e. the dimensions of the sensor unit should correspond substantially to the dimensions of a wafer. This poses in particular high demands on the structural height of such a sensor unit because wafers typically have a height of only about 0.7 to 1 mm.

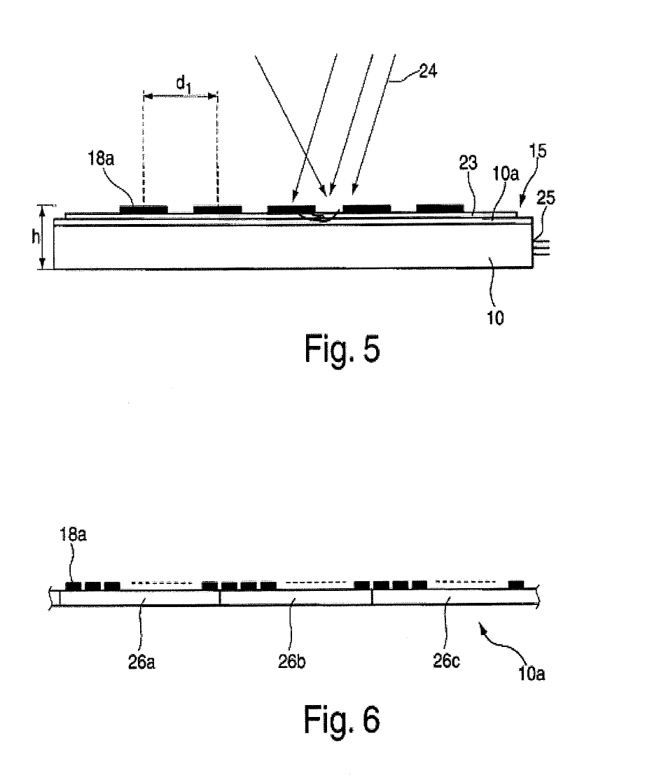

FIG. 5 shows a sensor unit 15, in which the second grating pattern or the grating lines 18a of the second grating pattern 8 are arranged directly, i.e. without connecting a relay optical unit in between, on the detector 10, which is configured in the form of a CCD camera chip. The grating lines 18a can in this case be arranged on a thin substrate (not shown in FIG. 5) (typically with a thickness of less than 20 μm) or directly on a protective glass 23 for protection of a light-sensitive detector surface 10a of the detector 10. In order to transmit measurement data or measurement signals of the sensor unit 15 to an external evaluation apparatus, electrical contacts 25 are provided laterally on the detector 10 so as not to increase the structural height of the sensor unit 25. The protective glass 23 here has a low thickness of for example approximately between 1 μm and 100 μm, typically between approximately 10 μm and approximately 50 μm.

The protective glass 23 is configured as a frequency conversion element for wavelength conversion and replaces a conventional protective glass for the light-sensitive detector surface 10a of the CCD chip 10. The protective glass 23 serves for frequency conversion of radiation 24 which is incident on the sensor unit 15. The radiation 24 can here be for example in the DUV wavelength range or in the EUV wavelength range and be converted by the protective glass 23 into radiation in the visible wavelength range. In the first case, the protective glass can be composed of a fluorescent glass, which enables the frequency conversion from the DUV into the VIS wavelength range, in the second case it can be composed of a scintillation glass, which enables frequency conversion from the EUV wavelength range into the VIS wavelength range.

Owing to the use of the protective glass 23 as frequency conversion element, it is possible to omit a relay optical unit and thus for a structural height h of the sensor unit 15 to be attained which is below for example approximately 1.2 mm and thus in the order of magnitude of the height of a wafer, so that the sensor unit 15 can be introduced into different lithography apparatuses in place of a wafer, in particular if these lithography apparatus wafer stages have depressions for example with a height of in the range of 0.1 to 0.5 mm for receiving a wafer.

The protective glass 23 in the form of the frequency conversion element in particular ensures that the grating lines 18a are not transferred onto the light-sensitive surface 10a. If it is assumed that the individual pixels 26a to 26c (cf. FIG. 6) of the light-sensitive surface 10a of the detector 10 have a size of approximately 10 μm to 10 μm and in the case of conventional Moiré gratings the number of the grating lines 18a is in the region of approximately 1000 to 2000 line pairs per mm, this results in a number of approximately 10 to 20 grating lines which contribute to the irradiation intensity per pixel 26a to 26c, i.e. a pitch d1 (cf. FIG. 5) of approximately 0.5 to 1 μm.

In the grating structures 16, 18 to 22, shown in FIGS. 2 and 3, the grating lines 16a, 18a to 22a, however, are situated more closely together, i.e. it is possible to achieve pitches d1 of for example 100 nm or even of only 50 nm. In this case (as, if appropriate, also with the use of EUV radiation), the number of grating lines 18a per pixel 26a to 26c can be for example 5000 or 10 000. Owing to the low pitch, the accuracy during measurement can be increased, which is expedient in particular for the comparison of a plurality of imaging optical systems with respect to multiple exposures, in particular double exposures.

For carrying out multiple exposures, in particular what is referred to as double exposure (“double patterning”), it must be ensured that the successive exposure operations lead to precisely overlaying latent images in the resist. In addition, deviations between different projection exposure apparatuses can lead to a narrowing of the allowed process window because these deviations use up part of the budget of available tolerances. With increasing demands on multiple exposures, for example in the form of quadruple exposures (cf. for example US 2010/0091257 A1), the production window will be reduced even further such that the demands for a pairing of the properties of lithography systems increase further.

In addition to the measurement by superposition of patterns, it is also possible in order to improve multiple exposures for a comparison between the aerial images of different lithography apparatuses to take place, to which end for example a device can be used as is illustrated in WO 2009/033709 A1 described in the introduction. The aerial image measurement can be carried out in particular with different illumination settings such as dipole or quadruple illumination, wherein flexible illumination pupils can also be used. Such flexible illumination pupils can be used in particular to compensate, in a targeted manner, for different system properties of the lithography apparatuses by modified illumination settings or suitable manipulators.

In particular, if each of the lithography apparatuses is provided with a dedicated measurement apparatus for aerial image measurement, such optical system pairings can also be carried out using the masks used for multiple exposure. The masks used are in this case typically slightly different because different steps of multiple exposure are involved here. These differences, too, can be detected by the aerial image detection and it is possible by varying the illumination settings to achieve that these differences appear exactly as desired in the aerial image.

To test the suitability of two lithography apparatuses for multiple exposure, in particular the variables “Critical Dimension” (CD) and distortion are essential because these substantially determine the precision of the mutual position of the partial images. If the above-described superposition measurement technology is not used, it is necessary for comparing the distortions with a precision which is comparable to the superposition measurement technology to compare the locations of the aerial image structures in the nm range with one another. Therefore the relative position of the magnifying optical units or cameras must be and remain known with this accuracy during the scanning of the aerial image. In order to preserve an exact relative position it is possible for example for both measurement apparatuses to be coupled rigidly to one another, for example by mounting them on a common substrate which can be manufactured for example from a material with a low coefficient of thermal expansion.

Alternatively in the incoherent aerial image measurement it is possible to dispense with a fixed coupling between the two measurement apparatuses by using identical masks and by measuring the lateral scan movements in each case only with respect to the respective optical axis. In the beginning or even during the measurement it is possible for identical patterns (for example crosses) in the aerial image to be targeted in order to obtain corresponding origins of the respective coordinate systems. In that case the two aerial images are measured in each case independently of one another but with lateral position determinations with nm accuracy. Subsequently the two aerial images are compared in terms of distortion and CD.

In this manner it is possible for the very same measurement apparatus to be used for measuring all the lithography systems to be compared because the origin of the coordinate systems used can be uniformly determined as described above. In addition to an incoherent aerial image measurement, a coherent aerial image measurement is also possible, which will be explained below in detail.

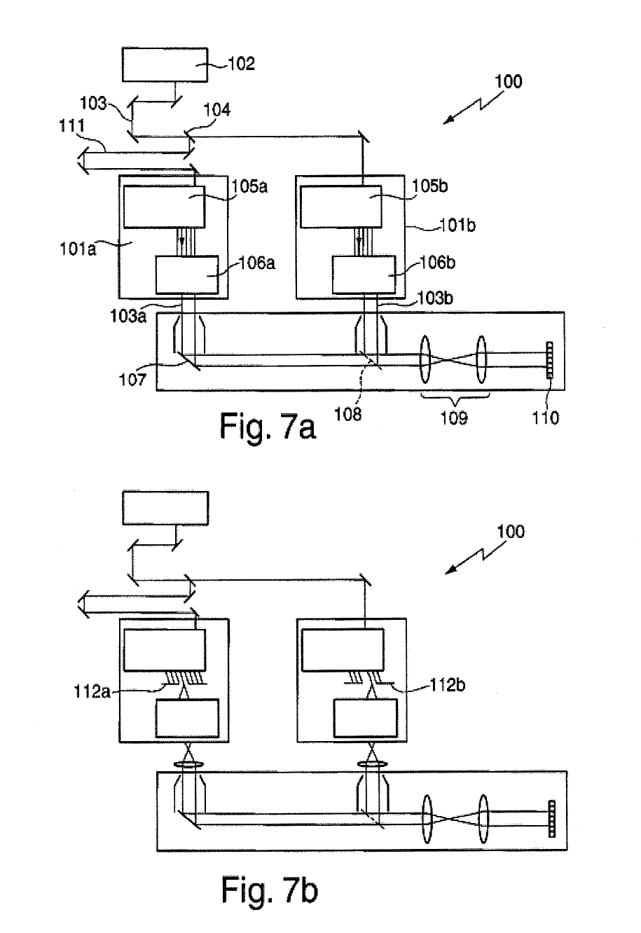

FIGS. 7a,b illustrate a measurement arrangement 100 for coherently comparing the aerial images of two lithography apparatuses 101a, 101b for wavelengths in the VUV range. The measurement arrangement 100 has a light source in the form of a laser 102 which serves for generating measurement radiation 103 for example of 193 nm, which is split via a beam splitter 104 into two partial rays 103a, 103b which are supplied to a respective lithography apparatus 101a, 101b to be measured. The beam splitter 104 can be arranged for example at the position of what is known as a beam steering mirror. Owing to the beam splitting, the generation of two partial rays 103a, 103b which have a phase coupling with respect to one another is made possible.

Each of the lithography apparatuses 101a, 101b has an illumination system 105a, 105b and a projection objective 106a, 106b. The two partial rays 103a, 103b pass through the respective lithography apparatus 101a, 101b and are deflected via a deflection mirror 107 or a partially transmissive mirror 108 and are coherently superposed. An imaging optical unit 109 serves for imaging the superposed partial rays 103a, 103b onto a spatially resolving detector 110, for example onto a CCD camera. The components which are necessary on the image side for the aerial image measurement can be accommodated in a structural unit which is common to both lithography systems 101a, 101b.

The measurement arrangement 100 corresponds in terms of construction substantially to a Mach-Zehnder interferometer. In order to ensure coherent superposition of the two partial rays 103a, 103b and thus a comparison of the aerial images, the spatial coherence length of the radiation used must not be exceeded. In order to ensure this, the optical distance covered by the two partial rays 103a, 103b must be nearly identical. In order to be able to match the optical distance covered by the first partial ray 103a to the distance covered by the second partial ray, a variable delay section 111 for phase-shifting for the first partial ray 103a is provided in the measurement arrangement 100.

In the measurement arrangement 100 in FIG. 7a, the illumination systems 105a, 105b are set to coherent illumination (σ near zero) or partially coherent illumination, so that in a mask plane (not shown) which is located between the respective illumination system 105a, 105b and the respective projection objective 106a, 106b a parallel beam path or a superposition of parallel beam paths with slightly different angle distribution is present. In the measurement arrangement 100 in FIG. 7a it is possible to dispense with masks because wavefront aberrations are measured over areas and a mask would merely change the amplitude of the wavefronts locally.

When comparing the aerial images, the wavefronts of the two lithography apparatuses 101a, 101b which are configured as wafer scanners, including the aberrations of the respective illumination system 105a, 105b, are compared. Such an aberration comparison can take place both in a field-resolved manner and a polarization-dependent manner. In this case in particular the aberrations which are particularly relevant in multiple exposures, for example the coma-type proportions of the wavefront aberrations, can be compared if appropriate also in the field profile. The field resolution can in this case take place in that region in which the multiple exposure also takes place.

FIG. 7b shows the measurement arrangement of FIG. 7a, in which additionally a perforated mask 112a, 112b is inserted into the beam path of the respective partial ray 103a, 103b. Owing to the perforated mask 112a, 112b it is possible for a desired field point to be selected. The perforated mask 112a, 112b also masks the aberrations of the illumination system with the result that only the aberrations of the projection objectives 106a, 106b can be compared to one another.

In the measurement arrangement 100 described in FIGS. 7a,b for coherent characterization of two lithography apparatuses 101a, 101b it is possible for their aerial images to be compared to one another in situ such that the difference in the aerial image of the two lithography apparatuses 101a, 101b can be compared with one another directly, i.e. without the influence of the light source 102. In contrast, it is possible in an aerial image measurement which is carried out with two incoherent light sources or with two coherent but mutually incoherent light sources to only ever compare the optical effect of a combination of the light sources and the lithography systems with one another because the latter cannot completely compensate for the influences of the light source such as fluctuations or drifts. In addition, in an incoherent measurement of two (or more) lithography apparatuses, the error of the respective measurements is likewise measured so that a subsequent separation of the individual influences on the measurement must be carried out in order to be able to characterize the lithography apparatuses themselves.

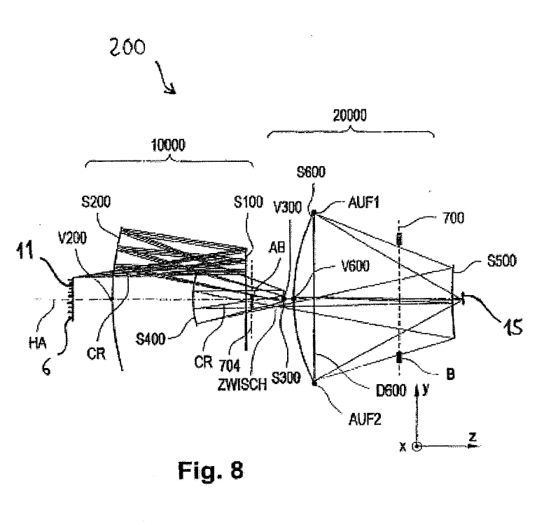

Finally, FIG. 8 shows the use of the device 1 described above in connection with FIG. 1 on an imaging optical system in the form of an obscurated EUV projection objective 200 for microlithography. Its construction is described in detail in WO 2006/069725 by the applicant (cf. FIG. 17 therein), which is incorporated in this application by reference. The projection objective 200 has six mirrors S100 to S600, four of which are arranged in a first partial objective 10000 and two of which are arranged in a second partial objective 20000, between which an intermediate image ZWISCH is formed. The mirror S200, which is second in the optical path, is configured as a concave mirror with a vertex V200 in order to obtain low angles of incidence. The third mirror S300 is configured as a convex mirror with a vertex V300.

The projection objective 200 has an aperture stop B, which is arranged in the beam path between the fifth mirror S500 and the sixth mirror S600 in a stop plane 700. A shading stop AB, which defines the obscuration, i.e. the inner radius of the illuminated field, is situated in the beam path between the third mirror S300 and the fourth mirror S400 in a further stop plane 704. The stop planes 700, 704 are conjugated to the entry pupil of the projection objective 200 and result as an intersection point of the chief ray CR with the optical axis HA of the projection objective 200.

Arranged in the object plane of the projection objective 200 is the first grating pattern 6, arranged on the substrate 11, of the device 1 in FIG. 1, arranged in the region of the image plane of the projection objective 200 is the sensor unit 15 with the second grating pattern 8 (not shown). As was already illustrated further above, in the obscurated projection objective 200 the pitches and/or the spatial orientation of the grating structures (cf. FIG. 3) can be selected such that a (partial) obscuration of the zeroth or higher orders of diffraction occurs at the shading stop AB, which has an effect on the image contrast of the superposition fringe pattern in the measurement of the projection objective 200 such that the obscuration, absorbing regions, stray-light range, aberrations etc. of the projection objective 200 can be determined.

1. Device configured to measure an imaging optical system by superposition of patterns, comprising:
a first grating pattern, which is configured to be positioned in a beam path upstream of the imaging optical system, and having a first grating structure,
a second grating pattern, which is configured to be positioned in the beam path downstream of the imaging optical system, and having a second grating structure, and
a sensor unit configured to measure, spatially resolved, a superposition fringe pattern produced during the imaging of the first grating structure of the first grating pattern onto the second grating structure of the second grating pattern, wherein
correction structures of the first grating structure differ from correction structures of the second grating structure.

2. Device according to claim 2, wherein the first grating structure has optical proximity correction (OPC) structures.

3. Device according to claim 2, further comprising:
an illumination system configured to illuminate the first grating structure of the first grating pattern, wherein at least one illumination parameter of the illumination system is matched to the correction structures.

4. Device according to claim 2, wherein the first and the second grating pattern each have a plurality of grating structures , and wherein pitches of the grating lines of different grating structures differ from one another.

5. Device according to claim 2, wherein the first and the second grating pattern each have a plurality of grating structures with mutually differing spatial orientation.

6. Device according to claim 5, wherein the pitches of the first grating structure are selected such that a zeroth or higher order of diffraction produced by the first grating structure is obscurated or absorbed at least partially by the imaging optical system.

7. Device according to claim 2, further comprising:
at least one movement apparatus configured to displace the grating patterns relative to one another.

8. Device according to claim 2, wherein the sensor unit comprises a spatially resolving detector and the second grating pattern in a common structural unit.

9. Device according to claim 9, wherein a frequency conversion element for wavelength conversion is arranged between the second grating pattern and the detector.

10. Device according to claim 10, wherein the frequency conversion element is configured as a protective glass for the spatially resolving detector.

11. Device according to claim 11, wherein the protective glass is a fluorescent glass or a scintillation glass.

12. Projection exposure apparatus for microlithography, comprising:
a projection objective as an imaging optical system, and
a device for measuring the projection objective according to claim 2.

13. Device according to claim 6, wherein the spatial orientation of the first grating structure are selected such that a zeroth or higher order of diffraction produced by the first grating structure is obscurated or absorbed at least partially by the imaging optical system.
